(19) United States
(12) Patent Application Publication
(10) Pub. No.: US 2021/0382752 A1
(43) Pub. Date: Dec. 9, 2021

(54) SERVER, APPARATUS, AND METHOD FOR ACCELERATING FILE INPUT-OUTPUT OFFLOAD FOR UNIKERNEL

(71) Applicant: Electronics and Telecommunications Research Institute, Daejeon (KR)

(72) Inventors: Yeon-Jeong JEONG, Daejeon (KR); Jin-Mee KIM, Daejeon (KR); Young-Joo WOO, Daejeon (KR); Yong-Seob LEE, Daejeon (KR); Seung-Hyub JEON, Daejeon (KR); Sung-In JUNG, Daejeon (KR); Seung-Jun CHA, Daejeon (KR)

(73) Assignee: Electronics and Telecommunications Research Institute, Daejeon (KR)

(21) Appl. No.: 17/340,986

(22) Filed: Jun. 7, 2021

(30) Foreign Application Priority Data
Jun. 8, 2020 (KR) 10-2020-0069214
May 3, 2021 (KR) 10-2021-0057436

(51) Int. Cl. G06F 9/48; G06F 9/50; G06F 9/54

(52) U.S. Cl. CPC G06F 9/4881; G06F 9/5016; G06F 9/546; G06F 2209/5018; G06F 2209/486; G06F 2209/548; G06F 2209/482

(57) ABSTRACT

Disclosed herein are an apparatus and method for accelerating file I/O offload for a unikernel. The method, performed by the apparatus and server for accelerating file I/O offload for the unikernel, includes; executing, by the apparatus, an application in the unikernal and calling, by the thread of the application, a file I/O function; generating, by the unikernal, a file I/O offload request using the file I/O function; transmitting, by the unikernal, the file I/O offload request to Linux of the server; receiving, by Linux, the file offload request from the thread of the unikernel and processing, by Linux, the file I/O offload request; transmitting, by Linux, a file FO offload result for the file I/O I/O offload request to the unikernel; and delivering the file I/O offload result to the thread of the application.

### CROSS REFERENCE TO RELATED APPLICATIONS

This application claims the benefit of Korean Patent Application No. 10-2020-0069214, filed Jun. 8, 2020, and No. 10-2021-0057436, filed May 3, 2021, which are hereby incorporated by reference in their entireties into this application.

### BACKGROUND OF THE INVENTION

### 1. Technical Field

The present invention relates generally to unikernal technology, and more particularly to technology for offloading file input-out (I/O), caused in a unikernal, to Linux and quickly processing file I/O.

### 2. Description of the Related Art

A unikernal is an image that is executable without a separate operating system (OS). The image contains the code of an application and all OS functions required to run the application. The unikernal combines the code of an application with the smallest subset of OS components required to run the application, thereby having an advantage in that the boot time, the space occupied thereby, and the number of attack surfaces thereof are significantly reduced.

The unikernal can be started and terminated more quickly and securely because the size thereof is much smaller than the size of an existing OS. In order to reduce the size, the unikernal does not include large-size modules, such as a file system, in the library thereof, and generally employs an offloading method in order to process file input-output (I/O).

However, file I/O offload is processed in such a way that the unikernal delivers an I/O offload request to the I/O offload proxy of a host server and then the I/O offload proxy performs the I/O and delivers the I/O offload result to the unikernal, and such a sequential procedure may reduce the speed of processing, which is intended to be the advantage of the unikernal.

Accordingly, in order to improve the performance of an application that requires file I/O in the operating environment of a unikernal, an I/O offload acceleration function capable of improving the speed of the existing low-speed I/O offload between the I/O offload proxy of Linux and the unikernal is required. To this end, the present invention presents an acceleration method through which file I/O offload between a unikernel and the I/O offload proxy of Linux can be quickly processed.

Meanwhile, Korean Patent Application Publication No. 10-2016-0123370, titled “File accessing method and related device”, discloses application of a file access method and a device related thereto to file access in a scenario in which a file system resides in memory.

### SUMMARY OF THE INVENTION

An object of the present invention is to accelerate file I/O offload caused in a unikernel.

Another object of the present invention is to increase the conventionally low-speed file I/O performance, thereby improving the availability of the application of a unikernal.

A further object of the present invention is to facilitate construction of an I/O system of a unikernel using a software stack (a file system, a network file system, and the like) of a general-purpose OS, which is difficult to construct in a unikernel environment.

Yet another object of the present invention is to support each unikernel so as to be optimally performed while maintaining a lightweight size, without the need to construct a file system in each unikernal even though multiple unikernal applications are running.

In order to accomplish the above objects, an apparatus for accelerating file input-output (I/O) offload for a unikernal according to an embodiment of the present invention includes one or more processors and executable memory for storing at least one program executed by the one or more processors. The at least one program may be configured to execute an application in the unikernel such that a thread of the application calls a file I/O function, to generate a file I/O offload request using the file I/O function, to transmit the file I/O offload request to Linux of a host server, to receive a file I/O offload result, which is a result of processing the file I/O offload request, from Linux of the host server, and to deliver the file I/O offload result to the thread of the application.

Here, the at least one program may process file I/O offload by scheduling a thread of the unikernel for the file I/O offload such that the thread of the unikernel receives the file I/O offload result.

Here, the at least one program may generate a shared memory area and perform file I/O offload communication between Linux and the unikernel using a to circular queue method based on the shared memory area.

Here, Linux of the host server may assign multiple file I/O offload communication channels between the unikernal and Linux to a circular queue such that each of the multiple file I/O offload communication channels corresponds to each CPU core of the unikernel.

Here, the at least one program may check whether the file I/O offload result assigned to the circular queue corresponds to the file I/O offload request, thereby checking the file I/O offload request.

Here, when the file I/O offload result does not correspond to the file I/O offload request, the at least one program may schedule a thread corresponding to the file I/O offload request, rather than the thread scheduled to receive the file offload result, thereby accelerating the file I/O offload.

Here, when the circular queue is available, the at least one program may deliver the file I/O offload request to the circular queue, whereas when the circular queue is full, the at least one program may schedule another thread, rather than the thread corresponding to the file I/O offload request to be assigned to the circular queue, thereby accelerating the file I/O offload.

Also, in order to accomplish the above objects, a server for accelerating file input-output (I/O) offload for a unikernel according to an embodiment of the present invention includes one or more processors and executable memory for storing at least one program executed by the one or more processors. The at least one program may be configured to receive a file I/O offload request from a thread of the unikernal, to cause Linux to process the file I/O offload request, and to transmit a file I/O offload result from Linux to the unikernel.

Here, the at least one program may generate a shared memory area and perform file I/O offload communication with the unikernal using a circular queue method based on the shared memory area.

Here, the at least one program may check multiple file I/O offload communication channels assigned to a circular queue, thereby checking the file I/O offload request.

Here, the at least one program may call a thread in a thread pool, which takes a file I/O function and parameters required for executing the file I/O function as arguments thereof, using file offload information included in the file I/O offload request, thereby accelerating the file I/O offload.

Here, threads in the thread pool may process file I/O jobs in parallel, thereby accelerating the file I/O offload.

Here, the at least one program may assign the file I/O offload result, processed by the called thread, to the circular queue and deliver the file I/O offload result to the unikernal through the circular queue.

Also, in order to accomplish the above objects, a method for accelerating file input-output (I/O) offload for a unikernel, performed by an apparatus and server for accelerating file I/O offload for the unikernal, according to an embodiment of the present invention includes executing, by the apparatus for accelerating the file I/O offload, an application in the unikernel and calling a file I/O function; generating, by the unikernal, a file I/O offload request using the file I/O function; transmitting, by the unikernel, the file I/O offload request to Linux of the server; receiving, by Linux, the file I/O offload request from a thread of the unikernal, and processing, by Linux, the file I/O offload request; transmitting, by Linux, a file I/O offload result for the file offload request received from the unikernel; and delivering the file I/O offload result to the thread of the application.

Here, transmitting the file I/O offload request may be configured such that the unikernel and Linux generate a shared memory area and perform file I/O offload communication using a circular queue method based on the shared memory area.

Here, transmitting the file I/O offload request may be configured such that Linux assigns multiple file I/O offload communication channels between the unikernal and Linux to a circular queue such that each of the multiple file I/O offload communication channels corresponds to each CPU core of the unikernel.

Here, transmitting the file I/O offload request may be configured such that, when the circular queue is available, the file I/O offload request is delivered thereto, whereas when the circular queue is full, not a thread corresponding to the file I/O offload request to be assigned to the circular queue but another thread is scheduled, thereby accelerating the file I/O offload.

Here, processing the file I/O offload request may be configured such that, Linux checks the multiple file I/O offload communication channels assigned to the circular queue, thereby checking the file I/O offload request.

Here, processing the file I/O offload request may be configured to call a thread in a thread pool, which takes the file I/O function and parameters required for executing the file I/O function as arguments thereof, using file I/O offload information included in the file I/O offload request, thereby accelerating the file I/O offload.

Here, threads in the thread pool may process file I/O jobs in parallel, thereby accelerating the file I/O offload.

Here, delivering the file I/O offload result to the thread of the application may be configured such that, when the file I/O offload result does not correspond to the file I/O offload request, not the thread but a thread corresponding to the file I/O offload request is scheduled, thereby accelerating the file I/O offload.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating the process of offloading file I/O from a unikernal to a host server according to an embodiment of the present invention;

FIG. 2 is a block diagram illustrating a system for accelerating file I/O offload for a unikernal according to an embodiment of the present invention;

FIG. 3 and FIG. 4 are views illustrating an I/O offload acceleration process of a file I/O offload proxy according to an embodiment of the present invention;

FIG. 5 is a view illustrating a process in which file I/O offload is processed based on file I/O offload acceleration performed using a file I/O offload proxy and a unikernal according to an embodiment of the present invention:

FIG. 6 is a sequence diagram illustrating a method for accelerating file I/O offload for a unikernal according to an embodiment of the present invention; and

FIG. 7 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are is intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

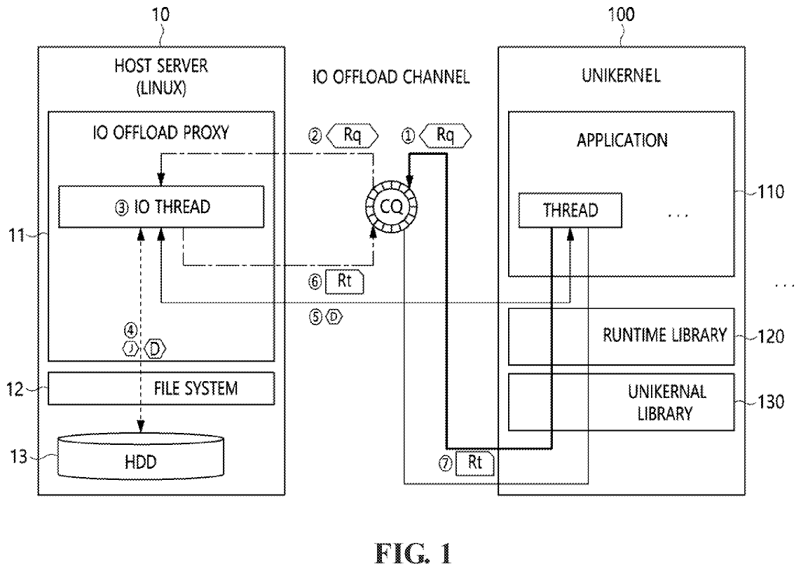

FIG. 1 is a view illustrating the process of offloading file I/O from a unikernal to a host server according to an embodiment of the present invention.

Referring to FIG. 1, it can be seen that the apparatus 100 for accelerating file I/O offload for a unikernel according to an embodiment of the present invention installs some resources in Linux of a host server 10 in order to perform file I/O in the unikernel and uses the resources as if they were a file system,

In FIG. 1, it can be seen that T denotes an I/O thread, Rq denotes an I/O offload request, J denotes an I/O job, Rt denotes an I/O offload result, D denotes data, and CQ denotes a circular queue.

The apparatus and method for accelerating file offload for a unikernel according to an embodiment of the present invention may perform acceleration such that data resident in Linux of the host server 10 is quickly input/output through file I/O when file I/O offload between the unikernal and Linux is processed.

When the unikernal delivers an I/O offload request for file I/O to an I/O offload proxy 11 installed in Linux, the I/O offload proxy 11 on Linux processes the I/O offload request delivered from the unikernal such that I/O offload requests are processed in parallel, thereby accelerating file I/O.

That is, the I/O offload proxy 11 of Linux generates multiple threads in order to perform I/O jobs in response to I/O offload requests, thereby generating a thread pool,

Here, in response to an I/O offload request, the I/O offload proxy 11 may immediately perform an I/O job using a thread generated in advance, without having to wait for the time taken to generate or terminate a thread.

Also, when it processes multiple I/O offload requests successively delivered from the unikernal, the I/O offload proxy 11 also performs an I/O job for the next I/O offload request using another thread, generated in advance and included in the thread pool, such that the I/O job is performed in parallel with the current I/O job, rather than waiting for the termination of the current I/O job for the I/O offload request that is currently being processed, thereby accelerating the I/O offload.

Meanwhile, when the I/O offload proxy 11 performs acceleration by processing I/O jobs in parallel in response to I/O offload requests from the unikernel, the application 110 of the unikernel immediately delivers the I/O offload result sent from the I/O offload proxy 11 of Linux to the thread corresponding thereto, thereby processing the I/O offload.

That is, upon receiving the I/O offload result from the I/O offload proxy 11 of Linux, the application 110 of the unikernal schedules the corresponding thread to immediately run such that the corresponding thread receives the result, without waiting until the corresponding thread is to be scheduled, thereby accelerating the I/O offload.

Accordingly, the present invention does not have to construct an additional file system software stack for file I/O in a unikernal, and may provide high-speed file I/O performance by mitigating file I/O performance degradation, which is a problem when offloading file I/O, whereby the availability of a unikernal application including file I/O may be improved.

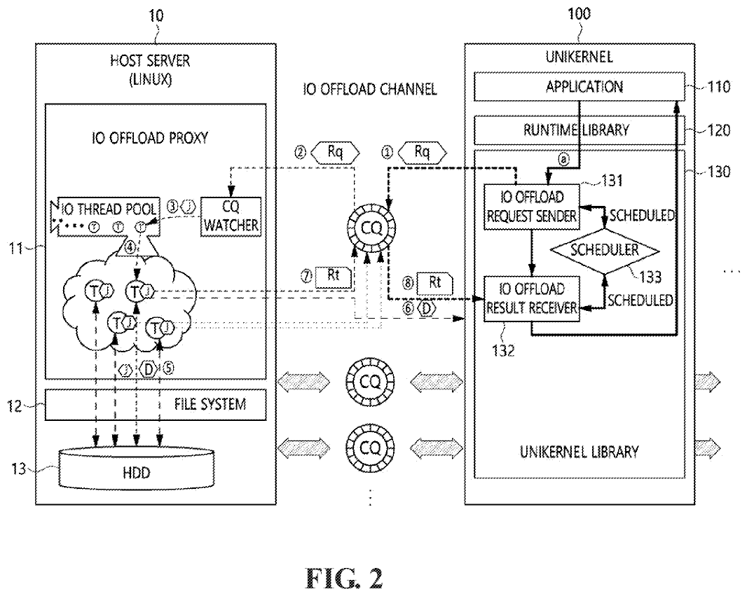

FIG. 2 is a block diagram illustrating a system for accelerating file I/O offload for a unikernal according to an embodiment of the present invention.

Referring to FIG. 2, the apparatus 100 for accelerating file I/O offload for a unikernal according to an embodiment of the present invention offloads file I/O caused in the unikernal to Linux of a host server 10, thereby inputting/outputting file data stored in Linux to/from the memory of the unikernal.

In FIG. 2, it can be seen that T denotes an I/O thread, Rq denotes an offload request, J denotes an I/O job, Rt denotes an I/O offload result, D denotes data, and CQ denotes a circular queue.

The apparatus 100 for accelerating file I/O offload for a unikernel is configured such that the I/O offload proxy 11 of Linux processes I/O jobs in parallel in response to I/O offload requests delivered from a unikernal, thereby accelerating I/O offload.

Here, the apparatus 100 for accelerating file I/O offload for a unikernal may accelerate I/O offload in such a way that, when an I/O offload result from Linux arrives at the unikernal via a communication channel, a thread corresponding thereto is scheduled to immediately receive and process the I/O offload result.

The apparatus 100 for accelerating file I/O offload for a unikernel may deliver an I/O offload request from the unikernel to the I/O offload proxy 11 of Linux.

The I/O offload proxy 11 may process file I/O in response to the I/O offload request, and may deliver the file I/O offload result to the unikernal.

The I/O offload proxy 11 may generate a shared memory area between the unikernel and the I/O offload proxy, and may deliver data using a circular queue (CQ) method based on the shared memory.

The I/O offload communication channel between the unikernal and Linux is configured such that a single communication channel CQ is assigned for each CPU core, so the total number of communication channels may be equal to the number of all cores for the unikernel.

Also, the I/O offload proxy 11 may include a circular queue (CQ) watcher for checking whether an I/O offload request is present in the communication channel CQ and a thread pool for performing I/O jobs included in the I/O offload requests delivered from the CQ watcher.

The thread pool may be generated for each communication channel or for each unikernel, and each thread pool may include multiple threads, which are generated in advance in order to perform I/O jobs.

For example, the number of threads in the thread pool may be the number of CQ elements when the thread pool is generated for each communication channel, or may be set by multiplying the number of CQ elements by the number of channels assigned to the unikernal when the thread pool is generated for each unikernel.

The CQ watcher may check the communication channels for which the CQ watcher is responsible, and may deliver I/O jobs to the thread pool, whereby the thread pool may run the thread.

That is, the CQ watcher may check the communication channels for which it is responsible. When an offload request is present in a certain communication channel, the CQ watcher may deliver the I/O job included in the I/O offload request to the thread pool.

Meanwhile, in order to process the I/O job delivered from the CQ watcher, the thread pool may generate multiple threads in advance and prepare the same in a standby state. The thread pool may select one of the threads that are waiting for an I/O job and use the same to perform the I/O job delivered from the CQ watcher.

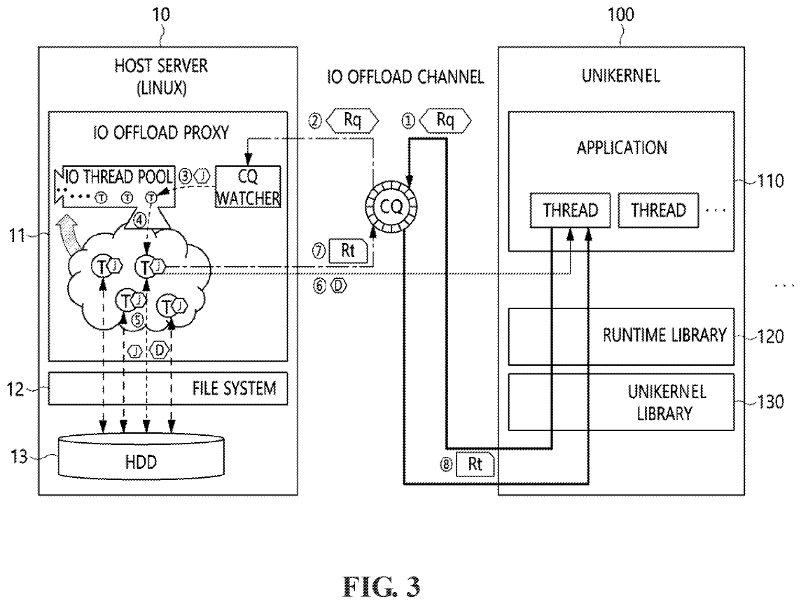

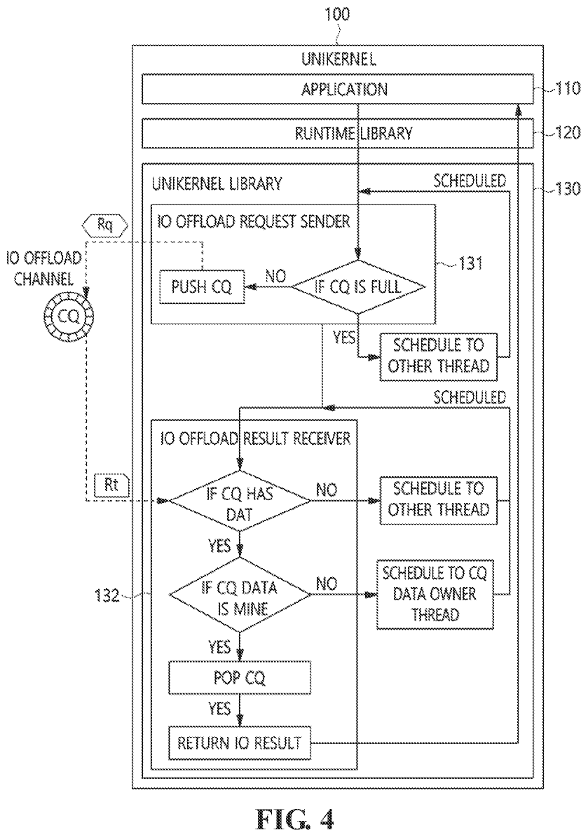

FIG. 3 and FIG. 4 are views illustrating a process in which a file I/O offload proxy accelerates I/O offload according to an embodiment of the present invention.

In FIG. 3 and FIG. 4, it can be seen that T denotes an I/O thread, Rq denotes an I/O offload request, J denotes an I/O job, Rt denotes an I/O offload result, D denotes data, and CQ denotes a circular queue.

Referring to FIG. 3, it can be seen that a process in which a unikernal delivers an I/O offload request to an I/O offload proxy 11 and the I/O offload proxy 11 processes the I/O offload request and delivers the I/O offload result to the unikernel is illustrated.

When the application of the unikernal executes an I/O function, an I/O offload request corresponding thereto may be input to the circular queue (CQ) of the corresponding core through a unikernal library 130.

The CQ watcher of the I/O offload proxy 11 checks the CQ, thereby detecting that the I/O offload request of the unikernal is input.

The CQ watcher may run a thread in a thread pool by taking the I/O job for the I/O offload request as a parameter. Here, in the thread pool, threads that were created when the I/O offload proxy was run may be present in a standby state.

Here, the thread may perform I/O offload using the corresponding I/O function and the parameters of the function in the I/O job.

Here, the thread executes the I/O function, thereby performing I/O offload, such as reading data from the disk of a file-system-processing unit 12 or writing data thereto.

Here, data may be read from or written to the disk of the file-system-processing unit 12 at the address of the unikernel as the result of I/O offload performed by the thread.

I/O offloading, such as reading data from the disk of the file-system-processing unit 12 or writing data thereto, may be performed simultaneously with generation of an I/O offload result. That is, because the address of a buffer referenced by the I/O function is the virtual address of Linux to which the physical address of the unikernel is mapped, the result of execution of the I/O function in Linux may be reflected to the memory of the unikernel.

Here, the thread may input the I/O offload result to the CQ. Here, the I/O offload result may be the return value that is the result of execution of the I/O function. For example, when a read function succeeds, the return value may be the size of the read data, whereas when it fails, the return value may be −1.

Here, the unikernal may receive the I/O offload result from the I/O offload proxy 11, check the I/O offload result, and deliver the same as the return value of the I/O function executed by the application.

Meanwhile, in order to keep pace with the I/O offload proxy 11 of Linux, which processes multiple requests for file I/O offload in parallel, the unikernal may also simultaneously process the I/O offload requests in parallel.

Here, the unikernel may input I/O offload requests as long as a communication channel is available, such that the I/O offload proxy 11 of Linux processes as many I/O offload requests as possible.

Also, in order to quickly process the I/O offload result sent by the I/O offload proxy 11, the unikernal performs scheduling for the I/O offload result upon receiving the I/O offload result via the communication channel, thereby accelerating the I/O offload.

Here, the thread corresponding to the I/O offload result may immediately receive the I/O offload result.

Referring to FIG. 4, when an I/O function, such as a read or write operation, is executed in the application of an application-processing unit 110, a unikernal may invoke a system call for the I/O function in order to accelerate I/O offload.

Here, when it receives an I/O request, a unikernal library 130 may transmit an I/O offload request to the I/O offload proxy 11, and may receive the result of I/O offload.

Here, the unikernal library 130 may include an I/O offload request sender 131 and an I/O offload result receiver 132.

The I/O offload request sender 131 may check the circular queue (CQ) of a corresponding core in order to input the I/O offload request thereto.

Here, when the CQ is in an available state, the I/O offload request sender 131 may input the I/O offload request to the CQ of the corresponding core through a push operation and deliver the result thereof to the I/O offload result receiver in order to make the I/O offload result receiver receive the I/O result from the I/O offload proxy 11.

Here, when the CQ is full, the I/O offload request cannot be input to the CQ, and the I/O offload request sender 131 may schedule another thread to run.

Also, the I/O offload result receiver 132 may check a CQ and schedule a thread in order to check the I/O result received from the I/O offload proxy.

Here, the I/O offload result receiver 132 checks whether data input to the CQ is present, and may schedule another thread to run when there is no data in the CQ.

Also, when there is data input to the CQ, the I/O offload result receiver 132 may check whether the input data is the I/O offload result thereof.

Here, when the data is not the I/OF offload result thereof but the I/O offload result of another thread, the I/O offload result receiver 132 may schedule the corresponding thread to access the I/O offload result in the CQ.

Conversely, when the data is the I/O offload result of the I/O offload result receiver 132, the I/O offload result receiver 132 reads the data from the CQ through a pop operation, thereby receiving the I/O offload result and delivering the same to the application of the application-processing unit 110.

That is, the I/O offload result receiver 131 may improve the efficiency of file I/O of the unikernel and the utilization of the CPU by scheduling threads.

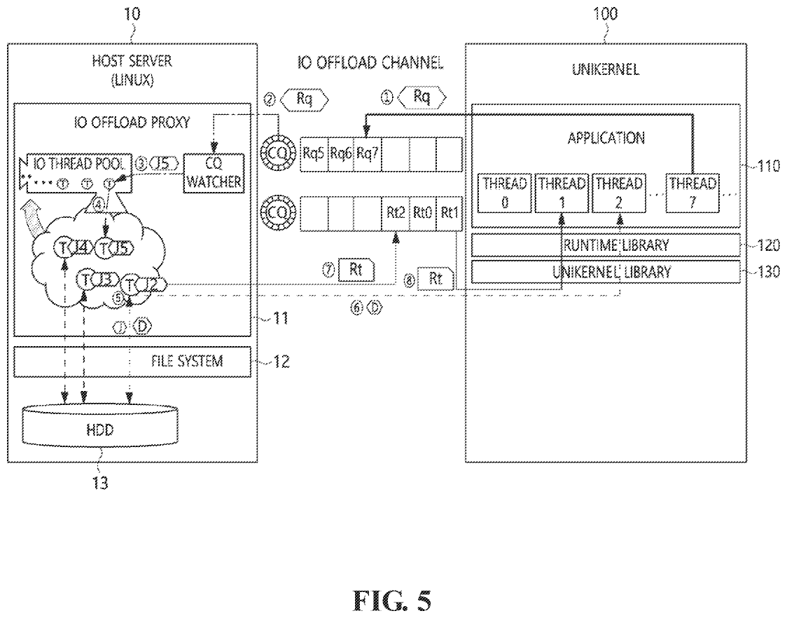

FIG. 5 is a view illustrating a process in which file I/O offload is processed based on file I/O offload acceleration performed using a file I/O offload proxy and a unikernal according to an embodiment of the present invention.

Referring to FIG. 5, it can be seen that a process in which file I/O offload is processed based on file I/O offload acceleration performed using a file I/O offload proxy and a unikernel is illustrated.

In FIG. 5, it can be seen that T denotes an I/O thread, Rq denotes an I/O offload request, J denotes an I/O job, Rt denotes an I/O offload result, D denotes data, and CQ denotes a circular queue.

First, it can be seen that thread7 in the unikernel inputs an I/O offload request Rq7 to the circular queue (CQ).

Here, the CQ watcher of Linux receives an I/O offload request Rq5 in the CQ and requests a thread T-J5 in a thread pool to perform an I/O job J5, whereby the thread T-J5 is started.

It can be seen that existing threads T-J3 and T-J5 simultaneously perform I/O jobs and that a thread T-J2 that completes an I/O job inputs an I/O offload result Rt2 to a CQ.

It can be seen that Thread1 of the unikernel reads an I/O offload result Rt1 from the CQ.

Accordingly, it can be seen that file I/O is accelerated through I/O offload using the CQs between the unikernel and the I/O offload proxy of Linux.

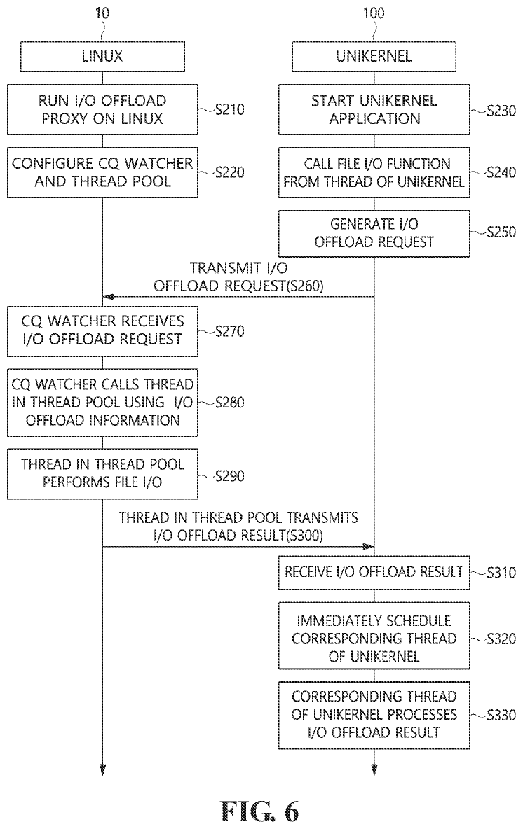

FIG. 6 is a sequence diagram illustrating a method for accelerating file I/O offload for a unikernal according to an embodiment of the present invention.

Referring to FIG. 6, in the method for accelerating file I/O offload for a unikernal according to an embodiment of the present invention, first, Linux of a host server 10 runs an I/O offload proxy at step S210.

Here, Linux of the host server 10 may configure a CQ watcher and a thread pool at step S220.

Also, in the method for accelerating file I/O offload for a unikernal according to an embodiment of the present invention, an application may be started at step S230 in the unikernal of the apparatus 100 for accelerating file I/O offload for the unikernel.

Here, the unikernal executes the application, whereby a thread may call a file I/O function at step S240.

Here, the unikernal may generate a file I/O offload request using the file I/O function at step S250.

Here, the unikernal may transmit the file I/O offload request to Linux of the host server 10 at step S260.

Here, at step S260, the file I/O offload request is delivered to a circular to queue, whereby a schedule for the file I/O offload request may be arranged.

That is, at step S260, when the circular queue is in an available state, the file I/O request is delivered thereto, whereas when the circular queue is full, not the thread corresponding to the file I/O offload request to be assigned to the circular queue but another thread is scheduled to run first, whereby file I/O offload may be accelerated.

Here, Linux of the host server 10 may receive the file I/O offload request through the CQ watcher at step S270.

Here, at step S270, Linux of the host server 10 and the unikernal may generate a shared memory area, and may perform file I/O offload communication using a circular queue method based on the shared memory area.

Here, at step S270, multiple file I/O offload communication channels between the unikernal and Linux may be assigned to the circular queue such that each of the multiple file I/O offload communication channels corresponds to each CPU core of the unikernel.

Here, Linux of the host server 10 may call a thread in the thread pool through the CQ watcher using the I/O offload information at step S280.

Here, at step S280, Linux of the host server 10 may check the multiple file I/O offload communication channels assigned to the circular queue, check the file I/O offload request, and call the thread in the thread pool by taking the file I/O function and parameters required for executing the file I/O function as arguments, which are acquired using the file I/O offload information included in the file I/O offload request.

Here, Linux of the host server 10 may process the file I/O offload using the thread of the thread pool at step S290.

Here, threads in the thread pool may process file I/O jobs in parallel, regardless of the sequence of the threads.

Here, Linux of the host server 10 may transmit the file I/O offload result to the unikernel using the thread in the thread pool at step S300.

Here, at step S300, Linux of the host server 10 may assign the file I/O offload result processed by the called thread to the circular queue, and may deliver the file I/O offload result to the unikernal through the circular queue.

Also, the unikernal may receive the file I/O offload result at step S310.

Here, the unikernal may deliver the file I/O offload result to the thread corresponding thereto, and may perform scheduling al step S320.

Here, at step S320, whether the file I/O offload result assigned to the circular queue corresponds to the file I/O offload request may be checked, and when the file I/O offload result does not correspond to the file 110 offload request, another thread corresponding to the file I/O offload request may be scheduled.

Here, the unikernal may process file I/O offload for the file I/O offload result using the corresponding thread at step S330.

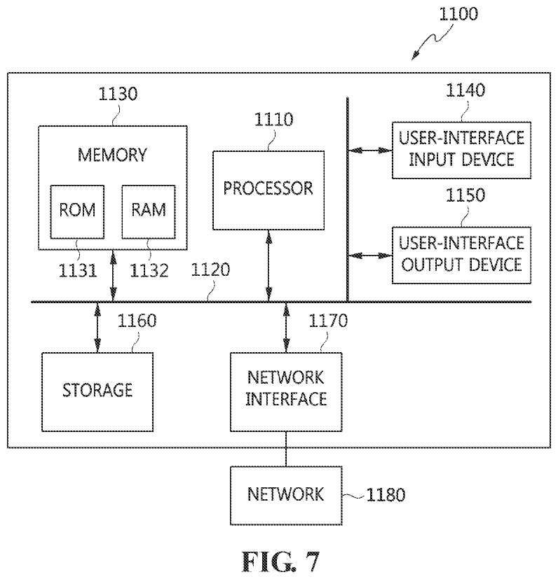

FIG. 7 is a view illustrating a computer system according to an embodiment of the present invention.

Referring to FIG. 7, the apparatus 110 for accelerating file I/O offload for a unikernal and the host server 10 corresponding to a file I/O offload acceleration server according to an embodiment of the present invention may be implemented in a computer system 1100 including a computer-readable recording medium. As illustrated in FIG. 7, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for accelerating file I/O offload for a unikernel according to an embodiment of the present invention includes one or more processors 1110 and executable memory 1130 for storing at least one program executed by the one or more processors 1110. The at least one program is configured to execute an application in a unikernal such that the thread of the application calls a file I/O function, to generate a file I/O offload request using the file I/O function, to transmit the file I/O offload request to Linux of a host server, to cause the unikernal to receive a file I/O offload result, which is the result of processing the file I/O offload request, from Linux of the host server, and to deliver the file I/O offload result to the thread of the application.

Here, the at least one program schedules a thread of the unikernel for file I/O offload such that the thread of the unikernel receives the file I/O offload result, thereby to accelerating the file I/O offload.

Here, the at least one program may generate a shared memory area, and may perform file I/O offload communication between Linux and the unikernel using a circular queue method based on the shared memory area.

Here, the at least one program may check whether the file I/O offload result assigned to the circular queue corresponds to the file I/O offload request.

Here, when the file I/O offload result does not correspond to the file I/O offload request, the at least one program may schedule a thread corresponding to the file I/O offload request, rather than the thread scheduled to receive the file I/O offload result, thereby accelerating file I/O offload.

Here, when the circular queue is in an available state, the at least one program delivers the file I/O offload request to the circular queue, whereas when the circular queue is full, the at least one program schedules another thread, rather than the thread corresponding to the file I/O offload request to be assigned to the circular queue, thereby accelerating the file I/O offload.

Also, a server for accelerating file I/O offload for a unikernal according to an embodiment of the present invention includes one or more processors 1110 and executable memory 1130 for storing at least one program executed by the one or more processors 1110. The at least one program may receive a file I/O offload request from a thread of the unikernal, cause Linux to process the file I/O offload request, and transmit a file I/O offload result from Linux to the unikernal.

Here, the at least one program may generate a shared memory area, and may perform file I/O offload communication with the unikernel using a circular queue method based on the shared memory area.

Here, the at least one program may assign multiple file I/O offload communication channels between the unikernal and Linux to the circular queue such that each of the multiple file I/O offload communication channels corresponds to each CPU core of the unikernel.

Here, the at least one program checks the multiple file I/O offload communication channels assigned to the circular queue, thereby checking the file I/O offload request.

Here, the at least one program calls a thread in a thread pool, which takes a file I/O function and parameters required for executing the file I/O function as the arguments thereof, using file I/O offload information included in the file I/O offload request, thereby accelerating the file I/O offload.

Here, threads in the thread pool process file I/O jobs in parallel, thereby accelerating the file I/O offload.

Here, the at least one program may assign the file I/O offload result processed by the called thread to the circular queue, and may deliver the file I/O offload result to the unikernal through the circular queue.

The present invention may accelerate file I/O caused in a unikernel.

Also, the present invention increases the conventionally low-speed file I/O performance, thereby improving the availability of the application of a unikernel.

Also, the present invention may facilitate construction of an I/O system of a unikernal using a software stack (a file system, a network file system, and the like) of a general-purpose OS, which is difficult to construct in a unikernel environment.

Also, the present invention may support each unikernel so as to be optimally performed while maintaining a lightweight size, without the need to construct a file system in each unikernel even though multiple unikernal applications are running.

As described above, the apparatus, server, and method for accelerating file I/O offload for a unikernel according to the present invention are not limitedly applied to the configurations and operations of the above-described embodiments, but all or some of the embodiments may be selectively combined and configured, so that the embodiments may be modified in various ways.

What is claimed is:

1. An apparatus for accelerating file input-output (I/O) offload for a unikernel, comprising:
one or more processors; and
executable memory for storing at least one program executed by the one or more processors,
wherein the at least one program is configured to
execute an application in the unikernal such that a thread of the application calls a file I/O function,
generate a file I/O offload request using the file function,
transmit the file I/O offload request to Linux of a host server,
cause the unikernel to receive a file I/O offload result, which is a result of processing the file I/O offload request, from the Linux of the host server, and
deliver the file I/O offload result to the thread of the application.

2. The apparatus of claim 1, wherein the at least one program processes file I/O offload by scheduling a thread of the unikernal for the file I/O offload such that the thread of the unikernal receives the file I/O offload result.

3. The apparatus of claim 2, wherein the at least one program generates a shared memory area and performs file I/O offload communication between the Linux and the unikernal using a circular queue method based on the shared memory area.

4. The apparatus of claim 3, wherein the at least one program checks whether the file I/O offload result assigned to a circular queue corresponds to the file I/O offload request.

5. The apparatus of claim 4, wherein, when the file I/O offload result does not correspond to the file I/O offload request, the at least one program schedules a thread corresponding to the file I/O offload request, rather than the thread scheduled to receive the file I/O offload result, thereby accelerating the file I/O offload.

6. The apparatus of claim 5, wherein, when the circular queue is available, the at least one program delivers the file I/O offload request to the circular queue, whereas when the circular queue is full, the at least one program schedules another thread, rather than the thread corresponding to the file I/O offload request to be assigned to the circular queue, thereby accelerating the file I/O offload.

7. A server for accelerating file input-output (I/O) offload for a unikernel, comprising:
one or more processors; and
executable memory for storing at least one program executed by the one or more processors,
wherein the at least one program is configured to
receive a file I/O offload request from a thread of the unikernal,
cause Linux to process the file I/O offload request, and
transmit a file I/O offload result from the Linux to the unikernel.

8. The server of claim 7, wherein the at least one program generates a shared memory area and performs file I/O offload communication with the unikernal using a circular queue method based on the shared memory area.

9. The server of claim 8, wherein the at least one program assigns multiple file I/O offload communication channels between the unikernal and the Linux to a circular queue such that each of the multiple file I/O offload communication channels corresponds to each CPU core of the unikernel.

10. The server of claim 9, wherein the at least one program checks the multiple file I/O offload communication channels assigned to the circular queue, thereby checking the file I/O offload request.

11. The server of claim 10, wherein the at least one program calls a thread in a thread pool, which takes a file I/O function and parameters required for executing the file I/O function as arguments thereof, using file I/O offload information included in the file I/O offload request, thereby accelerating the file I/O offload.

12. The server of claim 11, wherein threads in the thread pool process file I/O jobs in parallel, thereby accelerating the file I/O offload.

13. The server of claim 12, wherein the at least one program assigns the file I/O offload result, processed by the called thread, to the circular queue and delivers the file offload result to the unikernel through the circular queue.

14. A method for accelerating file input-output (I/O) offload for a unikernel, performed by an apparatus and server for accelerating file I/O offload for the unikernal, the method comprising:
executing, by the apparatus for accelerating the file I/O offload, an application in the unikernel and calling, by a thread of the application, a file I/O function;
generating, by the unikernel, a file I/O offload request using the file I/O function;
transmitting, by the unikernel, the file I/O offload request to Linux of the server;
receiving, by the Linux, the file I/O offload request from a thread of the unikernal, and processing, by the Linux, the file I/O offload request;
transmitting, by the Linux, a file I/O offload result for the file I/O offload request to the unikernel; and
delivering the file I/O offload result to the thread of the application.

15. The method of claim 14, wherein transmitting the file I/O offload request is configured such that the unikernal and the Linux generate a shared memory area and perform file I/O offload communication using a circular queue method based on the shared memory area.

16. The method of claim 15, wherein transmitting the file I/O offload request is configured such that the Linux assigns multiple file I/O offload communication channels between the unikernal and the Linux to a circular queue such that each of the multiple file I/O offload communication channels corresponds to each CPU core of the unikernel.

17. The method of claim 16, wherein transmitting the file I/O offload request is configured such that, when the circular queue is available, the unikernel delivers the file I/O offload request to the circular queue, whereas when the circular queue is full, the unikernel schedules another thread, rather than a thread corresponding to the file I/O offload request to be assigned to the circular queue, thereby accelerating the file I/O offload.

18. The method of claim 14, wherein processing the file I/O offload request is configured such that, using file I/O offload information included in the file I/O offload request, the Linux calls a thread in a thread pool using the file I/O function and parameters required for executing the file I/O function as arguments thereof, thereby accelerating the file I/O offload.

19. The method of claim 18, wherein threads in the thread pool process file I/O jobs in parallel, thereby accelerating the file I/O offload.

20. The method of claim 14, wherein delivering the file I/O offload result to the thread of the application is configured such that, when the file I/O offload result does not correspond to the file I/O offload request, not the thread of the application but the thread of the unikernel corresponding to the file I/O offload request is scheduled, thereby accelerating the file I/O offload.
